(19) United States
(12) Patent Application Publication
(10) Pub. No.: US 2008/0101484 A1
(43) Pub. Date: May 1, 2008

(54) ICI mitigation method for high-speed mobile OFDM systems

(76) Inventors: Wen-Rong Wu, Hsinchu City (TW); Chao-Yuan Hsu, Ciaotou Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/590,885

(22) Filed: Nov. 1, 2006

(51) Int. Cl. H04K 1/10

(52) U.S. Cl. 375/260

(57) ABSTRACT

In high-speed mobile environments, the channel is time-varying within an OFDM symbol. This time-varying characteristic will destroy the orthogonality among subcarriers. Thus, the intercarrier interference (ICI) will occur and the system performance will be degraded. An ICI mitigation method for high-speed mobile OFDM systems is proposed, which explores the special structure of the ICI channel matrix and applies the Newton's iterative matrix inversion method. With our formulation, fast Fourier transform (FFT) can be used to reduce the computational complexity. The object of canceling the ICI can be accomplished without the need of any extra circuit.

### BACKGROUND OF THE INVENTION

1. Field of the Invention

The present invention relates to an intercarrier interference (ICI) mitigation method and, more particularly, to a method for canceling ICI generated due to the time-varying characteristic of channel.

2. Description of Related Art

In conventional orthogonal frequency division multiplexing (OFDM) systems, the channel attenuation in an OFDM symbol can be regarded as a constant. When the user is in high-speed mobile environments, the Doppler effect makes the channel attenuation in an OFDM symbol complex and time-variant. That is, a time-variant characteristic is generated. The time-variant rate depends on the speed of the user and the OFDM system parameters. In typical OFDM processing, it is assumed that the channel is quasi-static, i.e., the channel is static in an OFDM symbol. However, in high-speed mobile environments, this assumption is no longer held. The orthogonality of subcarriers will be destroyed, causing wrong demodulation at the receiving end. Thus, the system performance will be degraded. Therefore, how to reduce or cancel ICI generated by the time-varying channel is critical to OFDM systems.

In existent related research, the simple solution is to keep only the diagonal elements of the ICI channel matrix and to set other elements to zero. Because this modified ICI channel matrix is a diagonal matrix, the computation of its inverse is very simple. Taking the advantage of mutual canceling of a matrix and its inverse, the received signal is multiplied by the inverse of the modified ICI channel matrix to cancel the interference. However, because too many elements are omitted, the actual interference canceling effect is not ideal. Two well-known ICI mitigation algorithms having good interference canceling effect are the zero-forcing (ZF) and minimum mean square error (MMSE) equalization methods. The ZF method similarly makes use of the idea of mutual canceling of a matrix and its inverse. When the number of subcarriers becomes large, however, the computation of the inverse will become very complex. That is, this method has the drawback of a too large amount of computation. In U.S. Pat. No. 6,816,452, the space between frequencies of subcarriers of OFDM is increased based on the Doppler shift caused by the mobile speed. Although the ICI can be reduced, the data transmission rate will drop. In U.S. Pat. No. 6,999,539, a linear derivative equalizer is provided to remove time-changing distortion and to form an equalized signal that is substantially free of non-static distortion. This method is similar to the ZF method. In order to obtain the equalizer, very complex computation of the inverse is required. In other words, a better interference canceling capability can only be obtained at the cost of a large amount of computation.

Accordingly, the present invention proposes a low-complexity ICI mitigation method to solve the above problems in the prior art.

### SUMMARY OF THE INVENTION

An object of the present invention is to provide an ICI mitigation method for high-speed mobile OFDM systems, which explores the special structure of the ICI channel matrix and applies the Newton's iterative matrix inversion method. With our formulation, fast Fourier transform (FFT) can be used to reduce the computational complexity.

Another object of the present invention is to provide an ICI mitigation method for high-speed mobile OFDM systems, which only exploits the circuit of the conventional OFDM system without the need of any extra circuit, hence effectively saving the circuit cost.

Yet another object of the present invention is to provide an ICI mitigation method for high-speed mobile OFDM systems, which can control the computation complexity according to different signal-to-noise ratios (SNRs).

To achieve the above objects, the present invention provides an ICI mitigation method for high-speed mobile OFDM systems, which comprises the steps of: calculating out an initial matrix of the inverse of an ICI channel matrix according to the channel characteristic of the OFDM system; multiplying a received signal by the initial matrix to get an iterative initial value; iteratively calculating out iterative values of other orders starting from the iterative initial value; and multiplying each iterative value by a corresponding weighting value and then adding them up to obtain a signal with no ICI.

In the above iterative step, the iterative value of the previous order is multiplied by a frequency-domain ICI channel matrix with the FFT/IFFT structure and then by the initial matrix to get an iterative value of the next order.

### BRIEF DESCRIPTION OF THE DRAWINGS

The various objects and advantages of the present invention will be more readily understood from the following detailed description when read in conjunction with the appended drawings, in which:

FIG. 1 is a flowchart according to an embodiment of the present invention;

FIG. 2 shows the BER performance comparison among the conventional method, the proposed method with the initial matrix calculated by Eq. (1), and the direct ZF method; and

FIG. 3 shows the BER performance comparison among the conventional method, the proposed method with the initial matrix calculated by Eq. (2), and the direct ZF method.

### DETAILED DESCRIPTION OF THE PREFERRED EMBODIMENTS

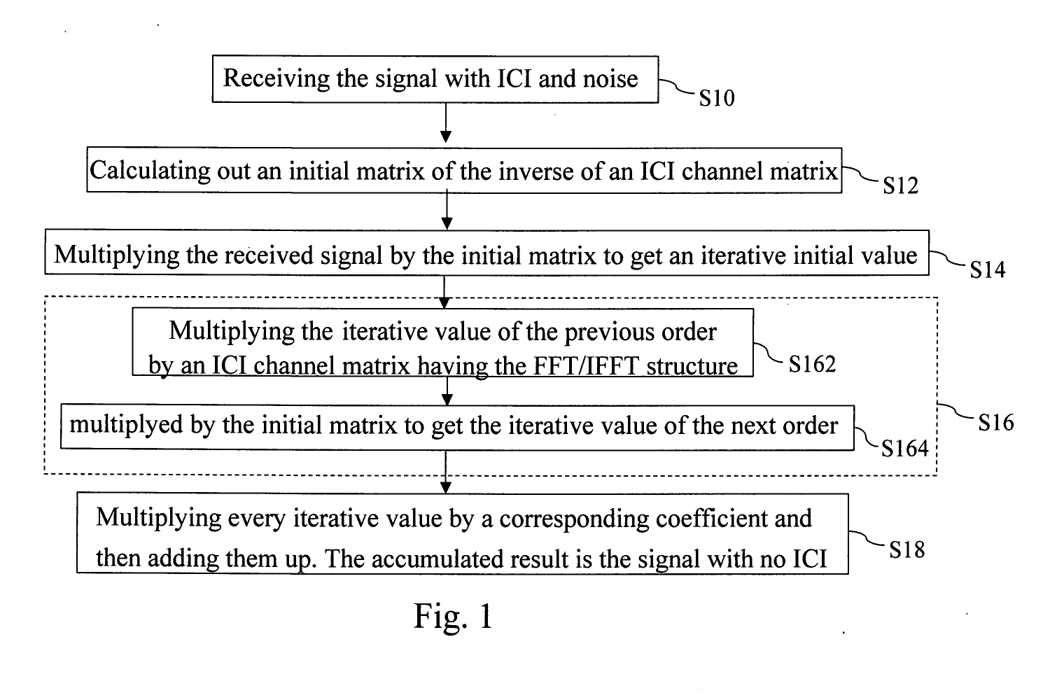

FIG. 1 is a flowchart according to an embodiment of the present invention. Because the channel has been estimated in advance, the channel characteristics such as the impulse response and frequency response are known. After the signal with ICI and noise is received (Step S10), an initial matrix X₀ of the inverse of an ICI channel matrix can be calculated out based on the channel characteristics (Step S12). X₀ is a diagonal matrix whose diagonal elements, [w₀, w₁, . . . , w_{N}_{_{c}}₋₁]^{T}, can be obtained from the following equation (1) or (2). Eq. (1) is derived from the minimum Frobenius norm criterion in Eq. (3), and Eq. (2) is the approximation of Eq. (1).

$$\begin{matrix}{w}_{i} = \frac{{\tilde{m}}_{i , i}^{*}}{{\sum }_{j = 0}^{{N}_{c} - 1} {\vert {\tilde{m}}_{i , j} \vert}^{2}} & ( 1 ) \\ {w}_{i} \approx \frac{{\tilde{m}}_{i , i}^{*}}{{\sum }_{j = mod ( i - S : i + S , {N}_{c} )} {\vert {\tilde{m}}_{i , j} \vert}^{2}} & ( 2 ) \\ {X}_{0} = arg {min}_{{X}_{0}} {‖ {I}_{{N}_{c}} - {X}_{0} \tilde{M} ‖}_{F}^{2} & ( 3 )\end{matrix}$$

where N_{c} is the number of subcarriers, \tilde{m}_{i,j} is the (i,j)-th element of the ICI channel matrix \tilde{M}, S=0˜N_{c}/2−1, and mod(x,y)=x−y└x/y┘. Because principal ICI terms on a subcarrier usually come from its neighboring subcarriers, the insignificant ICI terms in Eq. (1) are ignored in Eq. (2) to save the amount of computation. Because the time-varying channel impulse response can be formulated as hₖ(n)=hₖ+n×aₖ (hₖ is the static term and n×aₖ is the time-varying term), the received time-domain signal can be expressed as y=(H+DᵥA)x+z, where H and A are circulant matrices with the first columns [h₀, h₁, . . . , h_{N}_{_{c}}₋₁]^{T} and [a₀, a₁, . . . , a_{N}_{_{c}}₋₁]^{T}, respectively. The Dᵥ is a diagonal matrix with diagonal elements v=[0, 1, . . . N_{c}−1]^{T}, x is the transmitted signal, and z is the noise. The received frequency-domain signal \tilde{y} is obtained after y is discrete Fourier transformed. Therefore, the ICI channel matrix \tilde{M} can be obtained after the time-domain channel matrix (H+DᵥA) undergoes discrete Fourier transform (G) and then inverse discrete Fourier transform (G^{H}):

$$\begin{matrix}\tilde{M} = G ( H + {D}_{v} A ) {G}^{H} \\ = {D}_{\tilde{h}} + {GD}_{v} {G}^{H} {D}_{ \overline{a}}\end{matrix} \qquad ( 4 )$$

where D_{\tilde{h}}=GHG^{H}, and D_{ã}=GAG^{H}. Note that D_{\tilde{h}}, Dᵥ, and D_{ã} are all diagonal matrices.

After the initial matrix X₀ is calculated out, the product of the estimated inverse Xₖ of the ICI channel matrix \tilde{M} and the received signal \tilde{y} can be expressed as

$${X}_{k} \tilde{y} = {\sum }_{m = 0}^{{2}^{k} - 1} {{c}_{m}^{k} ( {X}_{0} \tilde{M} )}^{m} {X}_{0} \tilde{y}$$

after Newton's iteration, where k is the selected number of iterations and cₘ^{k} is the m-th coefficient in the k-th iteration. Note that the estimated matrix inverse formula

$${X}_{k} = {\sum }_{m = 0}^{{2}^{k} - 1} {{c}_{m}^{k} ( {X}_{0} \tilde{M} )}^{m} {X}_{0}$$

is obtained by expanding Newton's iteration and it is not the original form of Newton's iteration. The original form of Newton's iteration needs matrix-to-matrix multiplications and its computational complexity is even higher than the direct matrix inverse (ZF). The larger the k, the higher the number of iterations and the closer the Xₖ and the actual inverse at ordinary speeds, and therefore the better the interference canceling effect, but the higher the amount of computation. Usually, a good interference canceling efficiency can be accomplished after 3 to 4 iterations. Let x̅ₖ= X̅ₖ y̅ and s̅ₘ=(X₀\tilde{M})^{m}X₀\tilde{y}. The equalized result x̅ₖ can be expressed as Eq. (5):

$${\overline{x}}_{k} = {\sum }_{m = 0}^{{2}^{k} - 1} {c}_{m}^{k} {\overline{s}}_{m} \qquad ( 5 )$$

Note that s̅ₘ₊₁=(X₀\tilde{M}) s̅ₘ. Therefore, when calculating Xₖ\tilde{y} recursively, the received signal \tilde{y} is first multiplied by the initial matrix X₀ to get an iterative initial value s̅₀=X₀\tilde{y} (Step S14), and the iterative values s̅₁ to s̅₂_{^{k}}₋₁ are then iteratively calculated out (Step S16). Because the ICI channel matrix \tilde{M} is obtained after the time-domain channel matrix (H+DᵥA) undergoes the discrete Fourier transform and then the inverse discrete Fourier transform: \tilde{M}=D _{h̅}+GDᵥG^{H}D_{ā}, the iterative step S16 comprises two sub-steps: a step S162, in which the iterative value s̅ₘ of the previous order is multiplied by the ICI channel matrix having the FFT and IFFT structure, and a step S164, in which the result in Step S162 is multiplied by the initial matrix X₀ to obtain the iterative value of the next order: s̅ₘ₊₁. After the iterative values of all orders have been acquired, Eq. (5) is performed to multiply each iterative value s̅ₘ by a corresponding coefficient cₘ^{k} and then add them up. The accumulated result is the signal with no ICI, x̅ₖ.

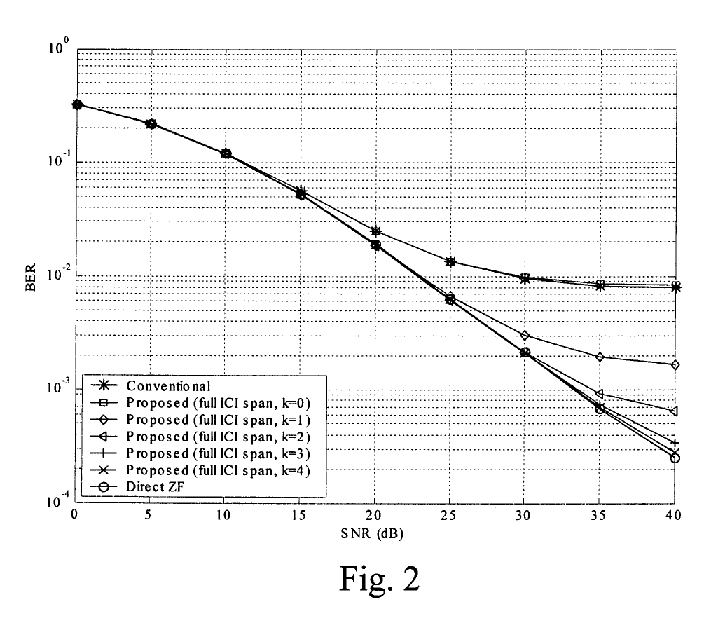

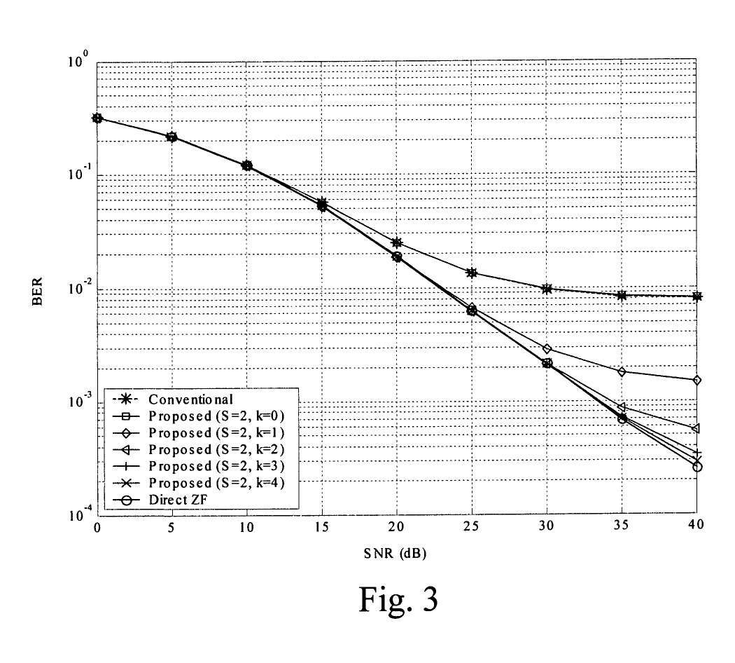

The present invention is compared with the direct ZF method and the conventional technique of keeping the diagonal elements of the ICI channel matrix for matrix inversion. We consider an OFDM system with N_{c}=128 and N_{g}=16 (guard interval). The modulation scheme for transmit signal is 16-QAM. The wireless channel length is set as 15. The wireless time-varying channel is generated by Jakes model. The normalized Doppler frequency shift (normalized by the subcarrier spacing) is 0.05. The parameters in the linear channel model, hₖ and aₖ, are obtained by the least-squares (LS) method. The initial matrix X₀ is obtained with Eq. (1). The simulation result is shown in FIG. 2. From FIG. 2, it is obvious that the proposed method can approach the direct ZF method with a small number of iterations (k=3 or 4). Moreover, with only a single iteration, the proposed method can achieve a much better interference canceling capability than the conventional technique of keeping the diagonal elements of the ICI channel matrix for matrix inversion. The simulation result in FIG. 3 is obtained with the initial matrix X₀ calculated by Eq. (2) and S is set as 2. From FIGS. 2 and 3, it is obvious that both the initial matrices calculated by Eqs. (1) and (2) can achieve the same interference canceling efficiency. The required complexity for the proposed method (S=2 and k=2, 3 4) and the direct ZF method is listed in Table I. It is obvious that all the numbers of real multiplications, real divisions, and real additions of the proposed method are much smaller than those of the direct ZF method. Therefore, making use of the above iterative operations, and FFT/IFFT, the present invention can effectively cancel ICI to lower the bit error rate (BER). The present invention also has the advantage of low complexity. Moreover, because the FFT/IFFT circuit already exists in the OFDM system, the present invention requires no extra circuit, hence saving the cost.

TABLE I

| | | Real | |
|---|---|---|---|
| Methods | Real multiplications | divisions | Real additions |
| The direct ZF method | 2943616 | 16512 | 2886336 |
| The proposed method | 18944 | 256 | 21888 |
| (k = 2 and S = 2) | | | |
| The proposed method | 41472 | 256 | 49024 |
| (k = 3 and S = 2) | | | |
| The proposed method | 86528 | 256 | 103296 |
| (k = 4 and S = 2) | | | |

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An ICI mitigation method for a high-speed mobile OFDM system comprising the steps of:
calculating out an initial matrix of the inverse matrix of an ICI channel matrix according to the channel characteristic in the OFDM system;
multiplying a received frequency-domain signal that is subjected to ICI by said initial matrix to get an iterative initial value;
iteratively calculating out iterative values of other orders starting from said iterative initial value; and
multiplying each said iterative value by a corresponding weighting value and then adding them up to obtain a signal with no ICI.

2. The method as claimed in claim 1, wherein said initial matrix is obtained by means of minimum Frobenius norm criterion.

3. The method as claimed in claim 1, wherein said initial matrix is a diagonal matrix.

4. The method as claimed in claim 3, wherein diagonal elements [w₀, w₁, . . . , w_{N}_{_{c}}₋₁]^{T} of said diagonal matrix are calculated out using
$${w}_{i} = \frac{{\tilde{m}}_{i , i}^{*}}{{\sum }_{j = 0}^{{N}_{c} - 1} {\vert {\tilde{m}}_{i , j} \vert}^{2}} or {w}_{i} \approx \frac{{\tilde{m}}_{i , i}^{*}}{{\sum }_{j = mod ( i - S : i + S , {N}_{c} )} {\vert {\tilde{m}}_{i , j} \vert}^{2}} ,$$
where N_{c} is the number of subcarriers, \tilde{m}_{i,j} is the (i,j)-th element of an ICI channel matrix \tilde{M}, and said ICI channel matrix \tilde{M} is obtained after performing discrete Fourier transform and inverse discrete Fourier transform to the channel characteristic: \tilde{M}=D_{\tilde{h}}+GDᵥG^{H}D_{ã}.

5. The method as claimed in claim 1, wherein the number of orders of said iterative values depends on the achievable ICI mitigation efficiency.

6. The method as claimed in claim 1, wherein in said iterative step, an iterative value of the previous order is multiplied by a frequency-domain ICI channel matrix having the FFT and IFFT structure and then by said initial matrix to get an iterative value of the next order.

7. The method as claimed in claim 1, wherein said weighting value is the coefficient of each order in expanded Newton's iteration.

8. The method as claimed in claim 1, wherein the step of multiplying each said iterative value by a corresponding weighting value and then adding them up is accomplished using
$${\overline{x}}_{k} = {\sum }_{m = 0}^{{2}^{k} - 1} {c}_{m}^{k} {\overline{s}}_{m} ,$$
where x̅ₖ is a signal with no ICI, s̅ₘ is said iterative value, and cₘ^{k} is said weighting value.
